(19) United States
(12) Patent Application Publication
(10) Pub. No.: US 2009/0292859 A1
(43) Pub. Date: Nov. 26, 2009

(54) INTEGRATED STORAGE DEVICE AND CONTROL METHOD THEREOF

(75) Inventors: Kung-Hsien Chu, Chiayi County (TW); Ming-Hsun Sung, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ITE TECH. INC., Hsinchu (TW)

(21) Appl. No.: 12/173,028

(22) Filed: Jul. 15, 2008

(30) Foreign Application Priority Data
May 21, 2008 (TW) 97118701

(51) Int. Cl. G06F 12/00

(52) U.S. Cl. 711/102; 711/E12.001

(57) ABSTRACT

An integrated storage device and a control method thereof are provided. The integrated storage device includes an interface controller, a microcontroller, a plurality of non-volatile storage devices, and a channel link controller. The interface controller retrieves a master control signal and a slave control signal sent by a motherboard. The microcontroller generates a selecting signal. The non-volatile storage devices have at least two storage types. The non-volatile storage devices are divided into a first group of storage device and a second group of storage device according to the selecting signal. The channel link controller respectively controls the first group of storage device and the second group of storage device according to the master control signal and the slave control signal. Thereby, the accessing efficiency of the integrated storage device is increased.

### CROSS-REFERENCE TO RELATED APPLICATION

This application claims the priority benefit of Taiwan application serial no. 97118701, filed on May 21, 2008. The entirety of the above-mentioned patent application is hereby incorporated by reference herein and made a part of specification.

### BACKGROUND OF THE INVENTION

1. Field of the Invention

The present invention relates to a storage device. More particularly, the present invention relates to an integrated storage device which may be equipped to an integrated drive electronics interface, and a controlling technique thereof.

2. Description of Related Art

Advanced technology attachment (ATA) is a controller technique. Integrated drive electronics (IDE) device is a disk drive technique matched to the ATA. Presently, the two terms “ATA” and “IDE” can be inter-used. The IDE is a low cost interface with modest performance, which is mainly designed for desktop computers.

Since cost of the IDE device is rather low, nearly all motherboards sold in the market are equipped with the IDE devices. Generally, the motherboard provides two IDE slots, and each of the IDE slots may connect two disk devices (a master disk device and a slave disk device) via cables. In other words, in the conventional technique, the IDE device of the motherboard may connect 4 disk devices.

As to a small system (for example, a barebone system or an embedded system), a conventional hard disk occupies a lot of spaces. Therefore, a two-silicon disc storage device is disclosed in a T.W patent No. 1272614, and detailed description thereof is as follows.

The two-silicon disc storage device takes the ATA interface as a basic structure, and two silicon disc storage devices are integrated as a single module. Such module has two independent storage devices, so that the cables and the cost thereof can be saved, and occupation of internal space by cables can be avoided, and accordingly a system size can be minimized.

In the two-silicon disc storage device, a first silicon disc storage device and a second silicon disc storage device are integrated on a same circuit board, so as to form the single module having two independent silicon disc storage devices. The two-silicon disc storage device is connected to the computer motherboard via the IDE interface. Based on setting of a jumper on the circuit board, the first silicon disc storage device can be set to be master, and the second silicon disc storage device can be set to be slave. After the master and the slave are set, two independent physical discs can be identified during operation of the computer, so that data can be stored in the first and the second silicon disc storage devices or read from the same.

It should be noted that according to the above technique, a single IDE slot on the motherboard can only connect two silicon disc storage devices.

Moreover, it should be noted that according to the above technique, one silicon disc storage device is composed of a control unit and at least one storage unit, and the single silicon disc storage device can only support the storage unit with a single storage type.

### SUMMARY OF THE INVENTION

Accordingly, the present invention is directed to an integrated storage device, which may decrease a hardware cost thereof.

The present invention is directed to a control method for an integrated storage device, which may improve an accessing efficiency of the integrated storage device.

The present invention provides an integrated storage device including an interface controller, a microcontroller, a plurality of non-volatile storage devices, and a channel link controller. The interface controller is coupled to an IDE interface of a motherboard for retrieving a master control signal and a slave control signal sent by the motherboard. The microcontroller is coupled to the interface controller for generating a selecting signal. The non-volatile storage devices have at least two storage types. The non-volatile storage devices are divided to a first group of storage device and a second group of storage device according to the selecting signal. The channel link controller is coupled to the interface controller, the microcontroller and the non-volatile storage devices. The channel link controller respectively controls the first group of storage device and the second group of storage device according to the master control signal and the slave control signal.

In an embodiment of the present invention, the storage types include a NAND flash memory storage type, a NOR flash memory storage type, a magnetic random access memory (RAM) storage type, and a battery-backed static random access memory (SRAM) storage type, and combinations thereof. In another embodiment, the NAND flash memory storage type includes a single level cell (SLC) storage type or a multi level cell (MLC) storage type. In still another embodiment, the NOR flash memory storage type includes the SLC storage type or the MLC storage type.

In an embodiment of the present invention, the microcontroller generates the selecting signal according to selecting information, and the selecting information can be stored in one of the non-volatile storage devices. In another embodiment, the integrated storage device further includes a memory coupled to the microcontroller for storing the selecting information, wherein the microcontroller generates the selecting signal according to the selecting information stored in the memory. In still another embodiment, the microcontroller may further control whether or not to disable the first group of storage device or the second group of storage device.

The present invention provides a control method for an integrated storage device. The integrated storage device includes a plurality of non-volatile storage devices. In the control method, a selecting signal is generated according to selecting information. In addition, the non-volatile storage devices are divided into a first group of storage device and a second group of storage device according to the selecting signal, wherein the non-volatile storage devices have at least two storage types. Further, a master control signal and a slave control signal transmitted from an IDE interface of a motherboard are retrieved. Moreover, the first group of storage device and the second group of storage device are respectively controlled according to the master control signal and the slave control signal.

In the present invention, the plurality of non-volatile storage devices of the integrated storage device can be divided into the first group of storage device and the second group of storage device according to the selecting signal. Moreover, the first group of storage device is controlled according to the master control signal sent from the motherboard, and the second group of storage device is controlled according to the slave control signal. Thereby, accessing efficiency of the integrated storage device is improved.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an integrated storage device according to an embodiment of the present invention.

FIG. 2 is a flowchart illustrating a control method for an integrated storage device according to an embodiment of the present invention.

### DESCRIPTION OF EMBODIMENTS

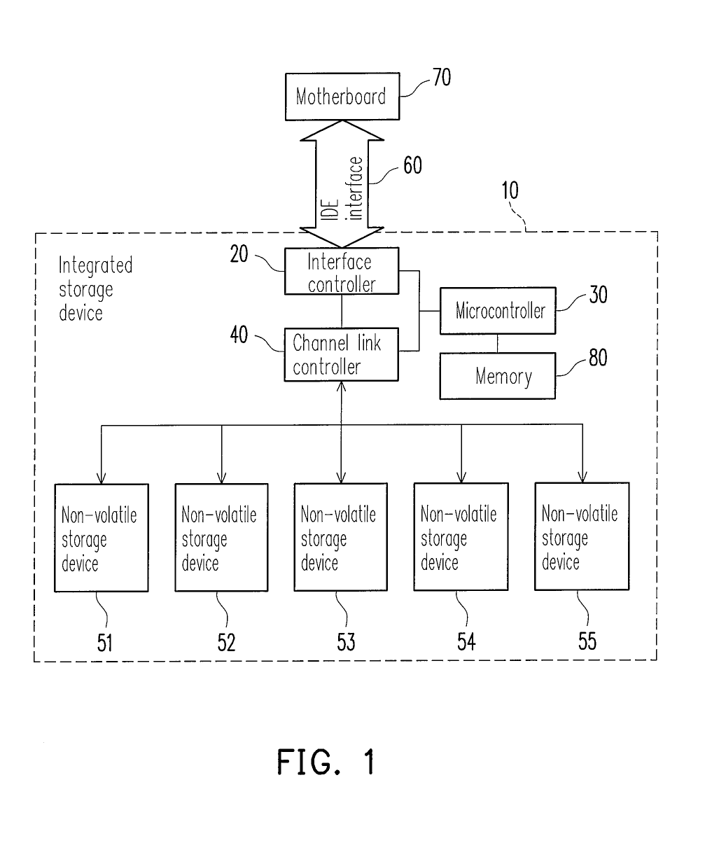

FIG. 1 is a schematic diagram illustrating an integrated storage device according to an embodiment of the present invention. Referring to FIG. 1, the integrated storage device 10 includes an interface controller 20, a microcontroller 30, a channel link controller 40, a memory 80 and a plurality of non-volatile storage devices. In the present embodiment, five non-volatile storage devices 51-55 are taken as an example, though the present invention is not limited thereto, and in another embodiment, other number of the non-volatile storage devices can also be applied.

The interface controller 20 may communicate with a motherboard 70 via an IDE interface 60. In other words, the interface controller 20 is used for retrieving a master control signal and a slave control signal sent by the motherboard 70. The memory 80 is used for storing selecting information. The microcontroller 30 is coupled to the interface controller 20 and the memory 80, and may generate a selecting signal according to the selecting information. The non-volatile storage devices 51-55 are divided into a first group of storage device and a second group of storage device according to the selecting signal. The channel link controller 40 is coupled to the interface controller 20, the microcontroller 30 and the non-volatile storage devices 51-55. The channel link controller 40 controls the first group of storage device according to the master control signal, and controls the second group of storage device according to the slave control signal.

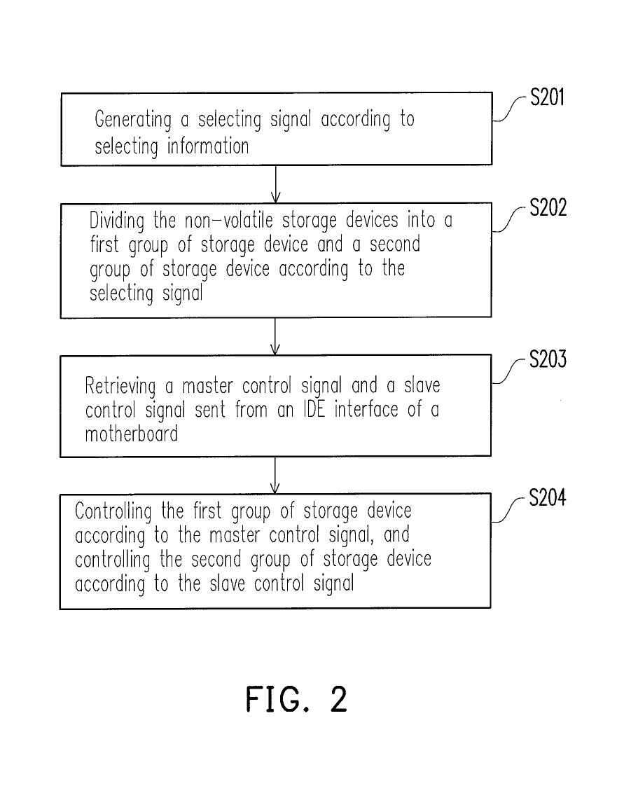

FIG. 2 is a flowchart illustrating a control method for an integrated storage device according to an embodiment of the present invention. Referring to FIG. 1 and FIG. 2, in the present embodiment, assuming the non-volatile storage devices 51-53 are SLC storage type NAND flash memories, and the non-volatile storage devices 54 and 55 are MLC storage type NAND flash memories. In the following content, the SLC and the MLC are briefly described first.

A difference between the SLC and the MLC is that for the SLC, an array thereof can store a binary digit, while the MLC is classified according to a number of electrons, so that an array thereof may store more than one bit. The SLC has advantages of fast accessing speed and low power consumption, while the MLC has an advantage of low cost. Since different types of non-volatile storage device have different advantages, in the present embodiment, the plurality of non-volatile storage devices 51-55 can be arbitrarily combined via the integrated storage device 10 to form the first group of storage device and the second group of storage device. By such means, elements of the first group of storage device and the second group of storage device can be adjusted according to different application environments, so as to fully make used of the advantages of different types of the non-volatile storage devices.

First, in step S201, the microcontroller 30 generates the selecting signal according to the selecting information stored in the memory 80. Next, in step S202, the channel link controller 40 divides the non-volatile storage devices 51-55 into the first group of storage device and the second group of storage device according to the selecting signal. In the present embodiment, according to the selecting signal, the storage types of the non-volatile storage devices can be detected, so as to divide the non-volatile storage devices into the first group of storage device and the second group of storage device. Therefore, the channel link controller 40 groups the non-volatile storage devices 51-53 into the first group of storage device, and groups the non-volatile storage devices 54 and 55 into the second group of storage device.

Next, in step 203, the interface controller 20 retrieves the master control signal and the slave control signal transmitted by the IDE interface 60 of the motherboard 70. Next, in step 204, the channel link controller 40 controls the first group of storage device according to the master control signal, and controls the second group of storage device according to the slave control signal. According to another aspect, the first group of storage device can be regarded as an independent physical hard disk, and the second group of storage device can be regarded as another independent physical hard disk. Therefore, when the motherboard 70 generates the master control signal to perform data accessing, the integrated storage device 10 may access the first group of storage device according to the master control signal. When the motherboard 70 generates the slave control signal to perform the data accessing, the integrated storage device 10 may access the second group of storage device according to the slave control signal.

Since the first group of storage device is composed of the non-volatile storage devices with the same storage type, not only the plurality of non-volatile storage devices with low cost can be combined to be the first group of storage device having high capacity, but also compatibility and stability of the system can be ensured. Deduced by analogy, the second group of storage device also has the similar advantages. On the other hand, in the present embodiment, the first group of storage device and the second group of storage device are integrated within the integrated storage device 10, so that the integrated storage device 10 may include two independent physical hard disks. By such means, number of cables can be reduced, so that cost thereof and a whole size thereof can be reduced accordingly. Moreover, the non-volatile storage device 51-55 can be implemented by memory type storage devices, and therefore compared to the conventional hard disks with mechanical shaft, the non-volatile storage devices of the present embodiment have the advantages of power-saving and low noise.

Referring to FIG. 1 again, the microcontroller 30 may further control whether or not to disable the first group of storage device or the second group of storage device. For example, if the IDE interface 60 is not only coupled to the integrated storage device 10, but is also coupled another IDE interface device (which is set to be slave), the microcontroller 30 may disable the first group of storage device or the second group of storage device, so as to avoid hardware confliction. The IDE interface device can be for example, a disk drive or a CD-ROM, etc. Besides, if the first group of storage device or the second group of storage device is not utilized for a period of time, the first group of storage device or the second group of storage device can also be disabled via the aforementioned method, so as to save the power.

Referring to FIG. 1 again, though the non-volatile storage devices 51-53 are grouped into the first group of storage device, and the non-volatile storage devices 54 and 55 are grouped into the second group of storage device according to the selecting information stored in the memory 80, the present invention is not limited thereto. Those skilled in the art may change the selecting information stored in the memory 80 according to an actual requirement, so that the elements included in the first group of storage device and the second group of storage device can be arbitrarily combined. For example, the selecting information stored in the memory 80 can be changed, so as to group the non-volatile storage devices 51 and 54 to be the first group of storage device, and group the non-volatile storage devices 52, 53 and 55 to be the second group of storage device. By such means, the first group of storage device and the second group of storage device may all have the SLC NAND flash memory.

Generally, for most of the actual situations, the applicable storage spaces of the first group of storage device and the second group of storage device are not totally utilized, and probably only a few storage spaces are utilized. Therefore, those unutilised spaces can be considered as a waste of cost. To reduce the waste of cost, the first group of storage device may include the non-volatile storage device 51 having features of relatively high cost, long lifespan and high accessing speed, and further include the non-volatile storage device 54 having features of relatively low cost, short lifespan, and low accessing speed. Therefore, when programs are about to be installed, the motherboard 70 may install the programs in the non-volatile storage device 51 of the first group of storage device in priority, so that the frequently used programs may have the relatively high accessing speed, and therefore accessing efficiency thereof is improved. When the applicable storage spaces of the non-volatile storage device 51 are insufficient, the non-volatile storage device 54 can be utilized, so that the problem of insufficient storage space can be resolved. Therefore, the advantages of the non-volatile storage devices 51 and 54 can be fully utilized. Deduced by analogy, the second group of storage device has the similar advantages.

It should be noted that though a possible pattern of the integrated storage device and the control method thereof are described in the above embodiments, those skilled in the art should understand that different manufactures have different designs for the integrated storage device and the control method thereof. Therefore, application of the present invention is not limited to such possible pattern. In other words, as long as a plurality of the non-volatile storage devices in the integrated storage device are divided into the first group of storage device and the second group of storage device, and the first group of storage device and the second group of storage device are respectively controlled according to the master control signal and the slave control signal sent by the motherboard, it is then considered to be matched with the spirit of the present invention. In the following content, other embodiments are provided to fully convey the spirit of the present invention to those skilled in the art.

Referring to FIG. 1 again, in the aforementioned embodiment, the selecting information is stored in the memory 80, though the present invention is not limited thereto, and in other embodiments, the selecting information can also be stored in other storage devices. For example, a specific region in the non-volatile storage device 51 can be laid out for storing the selecting information, and the specific region can be a protected region, in which data stored therein can only be changed via special command. Therefore, lost of the selecting information due to undesirable variation of the data can be avoided. By such means, the cost of the memory 80 can be saved.

Referring to FIG. 1 again, in the aforementioned embodiment, though the storage types of the non-volatile storage devices can be detected according to the selecting signal, so as to divide the non-volatile storage devices into the first group of storage device and the second group of storage device, the present invention is not limited thereto. In other embodiments, the accessing speed or storage spaces, etc. of the non-volatile storage devices can also be detected according to the selecting signal, so as to divide the non-volatile storage devices into the first group of storage device and the second group of storage device.

Referring to FIG. 1 again, in the aforementioned embodiment, though the storage devices with two storage types are taken as an example for the non-volatile storage devices 51-55, namely, the non-volatile storage devices 51-53 are the SLC NAND flash memories, and the non-volatile storage devices 54 and 55 are the MLC NAND flash memories, the present invention is not limited thereto. In other embodiments, the non-volatile storage devices 51-55 can also include three or more types of storage devices. For example, the non-volatile storage device 51 can be a SLC NOR flash memory, the non-volatile storage device 52 can be a MLC NOR flash memory, the non-volatile storage device 53 can be a magnetic RAM, and the non-volatile storage device 54 and 55 can be a battery-backed SRAM. In other words, the plurality of non-volatile storage devices in the integrated storage device 10 can be composed of the storage devices with various storage types.

In summary, according to the present invention, the plurality of non-volatile storage devices in the integrated storage device is divided into the first group of storage device and the second group of storage device according to the selecting signal. Moreover, the first group of storage device is controlled according to the master control signal sent from the motherboard, and the second group of storage device is controlled according to the slave control signal sent from the motherboard. Therefore, the accessing efficiency of the integrated storage device can be improved. Besides, the embodiments of the present invention have at least the following advantages:

1. The plurality of non-volatile storage devices with low cost can be combined to be a group of storage device having high capacity, and compatibility and stability of the system can be ensured.

2. Number of the cables can be reduced so as to reduce the cost and the whole size thereof.

3. The non-volatile storage devices can be implemented by memories, and therefore compared to the conventional hard disks, the non-volatile storage devices have the advantages of power-saving and low noise.

4. Advantages of non-volatile storage devices with different storage types can be fully utilized.

5. The selecting information can be flexibly adjusted, so that the integrated storage device can be applied to different application environments.

6. The selecting information can be stored in the non-volatile storage device, so that the hardware cost can be further saved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An integrated storage device, comprising:
an interface controller, coupled to an integrated drive electronics (IDE) interface of a motherboard, for retrieving a master control signal and a slave control signal sent from the motherboard;
a microcontroller, coupled to the interface controller, for generating a selecting signal;
a plurality of non-volatile storage devices, having at least two storage types, wherein the non-volatile storage devices are divided into a first group of storage device and a second group of storage device according to the selecting signal; and
a channel link controller, coupled to the interface controller, the microcontroller and the non-volatile storage devices, for controlling the first group of storage device according to the master control signal, and controlling the second group of storage device according to the slave control signal.

2. The integrated storage device as claimed in claim 1, wherein the storage types include a NAND flash memory storage type, a NOR flash memory storage type, a magnetic random access memory (RAM) storage type, and a battery-backed static random access memory (SRAM) storage type and combinations thereof.

3. The integrated storage device as claimed in claim 2, wherein the NAND flash memory storage type includes a single level cell (SLC) storage type or a multi level cell (MLC) storage type.

4. The integrated storage device as claimed in claim 2, wherein the NOR flash memory storage type includes a SLC storage type or a MLC storage type.

5. The integrated storage device as claimed in claim 1, wherein the microcontroller generates the selecting signal according to selecting information stored in one of the non-volatile storage devices.

6. The integrated storage device as claimed in claim 1, further comprising:
a memory, coupled to the microcontroller, for storing selecting information,
wherein the microcontroller generates the selecting signal according to the selecting information.

7. The integrated storage device as claimed in claim 1, wherein the microcontroller is further used for controlling whether or not to disable the first group of storage device or the second group of storage device.

8. A control method for an integrated storage device including a plurality of non-volatile storage devices, the control method comprising:
generating a selecting signal according to selecting information;
dividing the non-volatile storage devices into a first group of storage device and a second group of storage device according to the selecting signal, wherein the non-volatile storage devices have at least two storage types;
retrieving a master control signal and a slave control signal sent from an IDE interface of a motherboard; and
controlling the first group of storage device according to the master control signal, and controlling the second group of storage device according to the slave control signal.

9. The control method as claimed in claim 8, wherein the storage types include a NAND flash memory storage type, a NOR flash memory storage type, a RAM storage type, and a battery-backed SRAM storage type and combinations thereof.

10. The control method as claimed in claim 9, wherein the NAND flash memory storage type includes a SLC storage type or a MLC storage type.

11. The control method as claimed in claim 9, wherein the NOR flash memory storage type includes a SLC storage type or a MLC storage type.

12. The control method as claimed in claim 8, further comprising:
determining whether or not to disable the first group of storage device or the second group of storage device.
